(19) United States
(12) Patent Application Publication
(10) Pub. No.: US 2007/0218259 A1
(43) Pub. Date: Sep. 20, 2007

(54) LAMINATE, METHOD FOR MANUFACTURING THE LAMINATE AND METHOD FOR MANUFACTURING WIRING BOARD

(75) Inventors: Sentarou Yamamoto, Kirishima (JP); Kouji Yamamoto, Kirishima (JP); Mitsugi Ogawauchi, Kirishima (JP); Satoru Kajihara, Kirishima (JP)

Correspondence Address: DITTHAVONG MORI & STEINER, P.C., 918 Prince St., Alexandria, VA, 22314, US

(73) Assignee: KYOCERA Corporation, Kyoto (JP)

(21) Appl. No.: 11/686,678

(22) Filed: Mar. 15, 2007

(30) Foreign Application Priority Data
Mar. 16, 2006 (JP) 2006-72464

(51) Int. Cl. B32B 18/00; C03B 29/00

(52) U.S. Cl. 428/210; 156/89.16; 156/89.17; 156/89.18

(57) ABSTRACT

A laminate includes a first ceramic green sheet, a second ceramic green sheet, and a conductor layer. The first ceramic green sheet includes ceramic powder and an organic binder and has a firing shrinkage end temperature T₃. The second ceramic green sheet includes ceramic powder and an organic binder and has a firing shrinkage start temperature T₂ that is higher than the firing shrinkage end temperature T₃ of the first ceramic green sheet. The conductor layer includes metal powder and an organic binder and has a firing shrinkage end temperature T₄ that is lower than the firing shrinkage start temperature T₂ of the second ceramic green sheet.

### CROSS-REFERENCE TO RELATED APPLICATIONS

The present application claims priority under 35 U.S.C. §119 to Japanese Patent Application No. 2006-72464, filed Mar. 16, 2006, entitled “LAMINATE, METHOD FOR MANUFACTURING THE LAMINATE AND METHOD FOR MANUFACTURING.” The contents of this application are incorporated herein by reference in their entirety.

### BACKGROUND OF THE INVENTION

1. Field of the Invention

The present invention relates to a laminate, a method for manufacturing the laminate, and a method for manufacturing a wiring board.

2. Description of the Related Art

There have been demands for incorporation of various additional functions to wiring boards which include ceramic insulating substrates. Accordingly, wiring boards fabricated using combinations of different types of ceramic materials have been proposed. For example, a wiring board exhibiting high strength has been proposed in which a low-strength ceramic insulating layer is reinforced with a high-strength insulating layer. Furthermore, a wiring board incorporated with a high-capacitance capacitor has been proposed in which a high-dielectric-constant ceramic insulating layer or the like is disposed between low-dielectric-constant ceramic insulating layers.

In such wiring boards in which different ceramic insulating layers are stacked, in order to prevent occurrence of cracks and delamination in the ceramic insulating layers, characteristics of materials for the insulating layers are usually selected in such a manner that the ceramic insulating layers of different types have the same firing shrinkage and coefficient of thermal expansion.

However, recently, in order to reduce costs of wiring boards and increase accuracy during mounting of components, it has been required to decrease warpage and deformation resulting from the unevenness in shrinkage behavior during firing. Such a requirement has not been met in the known wiring boards.

In order to satisfy such a requirement, the following method has been proposed. Namely, to the surface of a laminate, a non-sintering ceramic green sheet that is not sintered at the firing temperature of the laminate is bonded, and then firing is performed. Thus, the shrinkage of the laminate is constrained by the non-sintering ceramic green sheet so that shrinkage occurs only in the thickness direction (in the Z direction). Then, the non-sintering ceramic green sheet is scraped off.

This method has a merit in that since the laminate can be constrained by the non-sintering ceramic green sheet, shrinkage in a direction parallel to the principal surface of the wiring board (in the X-Y plane direction) can be suppressed. However, the method has a demerit in that since the non-sintering ceramic green sheet must be scraped off after firing, the number of manufacturing steps increases and that since the non-sintering ceramic green sheet must be disposed of, the costs increase.

Accordingly, it has been proposed that when two types of ceramic green sheets having different firing shrinkage start temperatures are stacked and cofired, the ceramic green sheet A having a lower firing shrinkage start temperature is allowed to shrink, and then the ceramic green sheet B having a higher firing shrinkage start temperature is allowed to shrink, thus suppressing the dimensional change.

It has also been proposed that when two types of ceramic green sheets having different firing shrinkage start temperatures and a wiring layer are stacked and cofired, by controlling the volumetric shrinkage ratio and shrinkage start temperature of the conductor layer, delamination and cracks near the interface with the conductor layer are prevented.

However, in recent wiring boards, a smaller thickness and higher functionality are required. As a result, the thickness of each of the ceramic green sheets decreases, and the volume percentage of the conductor layer in the laminate increases. Consequently, warpage increases due to variations in firing shrinkage behavior in the ceramic green sheets and the conductor layer, which has been negligible in the past.

### SUMMARY OF THE INVENTION

According to one aspect of the present invention, a laminate includes a first ceramic green sheet, a second ceramic green sheet, and a conductor layer. The first ceramic green sheet includes ceramic powder and an organic binder and has a firing shrinkage end temperature T₃. The second ceramic green sheet includes ceramic powder and an organic binder and has a firing shrinkage start temperature T₂ that is higher than the firing shrinkage end temperature T₃ of the first ceramic green sheet. The conductor layer includes metal powder and an organic binder and has a firing shrinkage end temperature T₄ that is lower than the firing shrinkage start temperature T₂ of the second ceramic green sheet.

According to another aspect of the present invention, a method for manufacturing a laminate includes preparing at least one first ceramic green sheet containing ceramic powder and an organic binder, preparing at least one second ceramic green sheet containing ceramic powder and an organic binder and having a firing shrinkage start temperature T₂ that is higher than a firing shrinkage end temperature T₃ of the at least one first ceramic green sheet, and preparing a conductive paste containing metal powder and an organic binder. The conductive paste has a firing shrinkage end temperature T₄ that is lower than the firing shrinkage start temperature T₂ of the at least one second ceramic green sheet. The conductive paste is applied to a surface of at least one of the at least one first ceramic green sheet and to a surface of at least one of the at least one second ceramic green sheet, or is filled in a through-hole provided on at least one of the at least one first ceramic green sheet and at least one of the at least one second ceramic green sheet with the conductive paste. The at least one first ceramic green sheet and the at least one second ceramic green sheet including the at least one of the at least one first ceramic green sheet and the at least one of the at least one second ceramic green sheet on which the conductive paste is applied or whose through-hole is filled with the conductive paste are stacked.

According to further aspect of the present invention, a method for manufacturing a wiring board includes preparing at least one first ceramic green sheet containing ceramic powder and an organic binder, preparing at least one second ceramic green sheet containing ceramic powder and an organic binder and having a firing shrinkage start temperature T₂ that is higher than a firing shrinkage end temperature T₃ of the at least one first ceramic green sheet, and preparing a conductive paste containing metal powder and an organic binder. The conductive paste has a firing shrinkage end temperature T₄ that is lower than the firing shrinkage start temperature T₂ of the at least one the second ceramic green sheet. The conductive paste is applied to a surface of at least one of the at least one first ceramic green sheet and to a surface of at least one of the at least one second ceramic green sheet, or is filled a through-hole provided on at least one of the at least one first ceramic green sheet and at least one of the at least one second ceramic green sheet with the conductive paste. The at least one first ceramic green sheet and the at least one second ceramic green sheet including the at least one of the at least one first ceramic green sheet and the at least one of the at least one second ceramic green sheet on which the conductive paste is applied or whose through-hole is filled with the conductive paste are stacked to form a laminate. The laminate is fired.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic sectional view of an example of a wiring board according to an embodiment of the present invention; and

FIG. 2 is a graph showing shrinkage behaviors of a ceramic green sheet A, a ceramic green sheet B, and a conductor green sheet C constituting a laminate according to an embodiment of the present invention.

### DESCRIPTION OF THE PREFERRED EMBODIMENTS

The embodiments will now be described with reference to the accompanying drawings, wherein like reference numerals designate corresponding or identical elements throughout the various drawings.

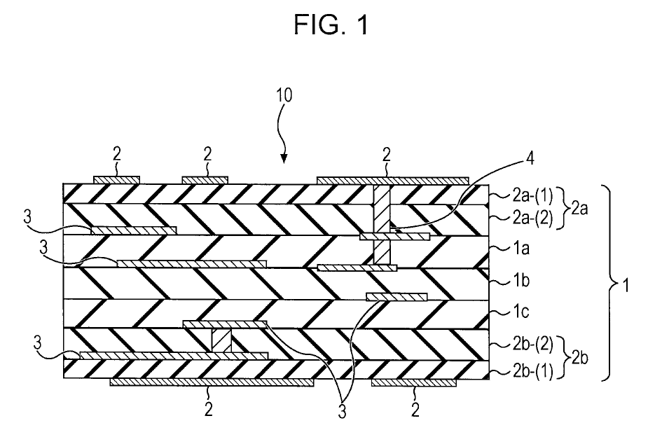

Referring to FIG. 1, a wiring board 10 includes a ceramic insulating substrate 1 in which ceramic insulating layers 1a to 1c and composite layers 2a and 2b are stacked, surface wiring layers 2 disposed on both surfaces of the insulating substrate 1, internal wiring layers 3 disposed inside the substrate 1, and via-hole conductors 4 for providing connections between wiring layers.

Each of the composite layers in the ceramic insulating substrate 1 is made of ceramic green sheets having different shrinkage start temperatures. The firing shrinkage start temperature of each of the green sheets to be formed into layers 2a-(1) and 2b-(1) by firing is lower than the firing shrinkage end temperature of each of the green sheets to be formed into the layers 2a-(2), 2b-(2), and 1a to 1c by firing. The firing shrinkage end temperature of each of the green sheets to be formed into the layers 2a-(1) and 2b-(1) by firing is lower than the firing shrinkage start temperature of each of the green sheets to be formed into the layers 2a-(2), 2b-(2), and 1a to 1c by firing. Furthermore, the firing shrinkage end temperature of each of the conductor layers to be formed into the surface wiring layers 2 and internal wiring layers 3 is lower than the firing shrinkage end temperature of each of the green sheets to be formed into the layers 2a-(1) and 2b-(1) by firing.

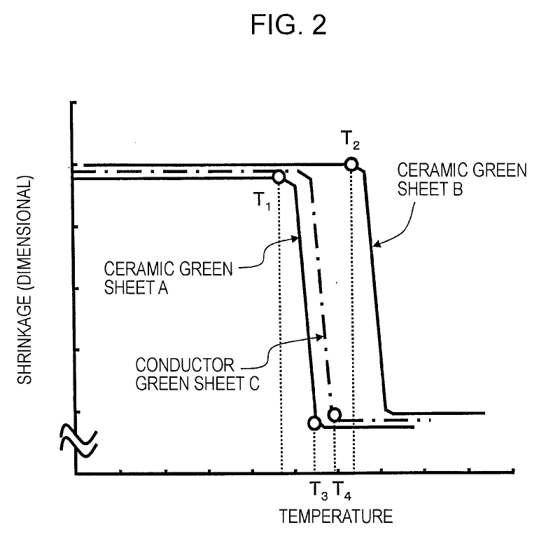

The outline of firing shrinkage behaviors of a first ceramic green sheet A, a second ceramic green sheet B, and a conductor green sheet C will be described with reference to FIG. 2 which shows firing shrinkage curves. The conductor green sheet C is formed by repeating the step of printing and drying a plurality of times, using a conductive paste for forming the conductor layer, to obtain a thickness of 100 μm. Using this, a firing shrinkage curve was measured.

In an embodiment of the present invention, the conductive layer is composed of a powder compact and is generally obtained by applying a conductive paste, followed by drying. Furthermore, the conductor green sheet has the same composition as the conductive paste and is formed into a green sheet or formed into a thick powder compact by repeating the step of applying the conductive paste onto a substrate and drying.

According to FIG. 2, it is important that the relationship T₁<T₂ is satisfied and T₂ is higher than T₃ and T₄, wherein T₁ represents the firing shrinkage start temperature of the ceramic green sheet A, T₂ represents the firing shrinkage start temperature of the ceramic green sheet B, T₃ represents the firing shrinkage end temperature of the ceramic green sheet A, and T₄ represents the firing shrinkage end temperature of the conductor green sheet C.

In the wiring board 10 shown in FIG. 1, the layers 2a-(1) and 2b-(1) of the ceramic insulating substrate 1 each correspond to the ceramic green sheet A, the insulating layers 2a-(2) and 2b-(2), and the insulating layers 1a to 1c each correspond to the ceramic green sheet B, and the surface wiring layers 2 and the internal wiring layers 3 each correspond to the conductor green sheet C.

It is important that at the time when the ceramic green sheet B starts to shrink in the course of firing, firing shrinkage of each of the ceramic green sheet A and the conductor green sheet C has ended.

The reason for this is that if the ceramic green sheet A and the conductor green sheet C are still in a firing shrinkage state when the ceramic green sheet B starts to shrink in the course of firing, the constraint force among the ceramic green sheets A and B and the conductor green sheet C during firing shrinkage does not work sufficiently, resulting in warpage due to unevenness in firing shrinkage behavior.

Each of the difference between the shrinkage start temperature T₂ of the ceramic green sheet B and the shrinkage end temperature T₃ of the ceramic green sheet A (T₂−T₃) and the difference between the shrinkage start temperature T₂ of the ceramic green sheet B and the shrinkage end temperature T₄ of the conductor green sheet C (T₂−T₄) is preferably 10° C. or higher, and more preferably 20° C. or higher.

The reason for this is that as the temperature range in which both types of ceramic green sheets shrink during firing decreases, the effect of shrinkage constraint increases. The term “firing shrinkage end temperature” refers to a temperature at which firing shrinkage reaches about 99% of the final volumetric firing shrinkage amount.

The firing end temperature of a known conductor layer is lower than the firing start temperature of the ceramic green sheet B. The shrinkage curve of the conductor layer can be adjusted by adjusting the composition of the ceramic material, in particular, glass, constituting the ceramic green sheet, the average particle size of glass powder, the packing density of the laminate, the particle size of metal powder contained in the conductor layer, etc.

Each of the ceramic green sheet A and the ceramic green sheet B contains ceramic powder and an organic binder. The ceramic material for the ceramic powder may be any of an insulating substance, a dielectric substance, and a magnetic substance. At least two types of ceramic materials having different firing shrinkage start temperatures to be selected may be, for example, ceramic materials having different compositions, or ceramic materials having an identical composition but having different ceramic particle distributions or different specific surface areas so that different firing shrinkage start temperatures are obtained.

In addition to the difference in the firing shrinkage start temperature, the ceramic materials used for the ceramic green sheets A and B may have different properties, such as different relative dielectric constants, different strengths, or different dielectric losses, depending on the intended use.

The ceramic material is desirably cofirable with the conductor layer having low resistance. Therefore, it is desirable to use a ceramic material that can be fired at a low temperature of 1,050° C. or lower, and in particular, a ceramic material that can be cofired with Ag, which can be fired in air, at 960° C. or lower, and preferably at 920° C. or lower. Examples of such a low-temperature firable ceramic material include known low-temperature firable ceramic materials, such as glass powder, mixed powder of glass powder and ceramic powder, and oxide-containing mixed powder.

Accordingly, the firing temperature of the ceramic material constituting each of the ceramic green sheets A and B can be decreased by incorporation of glass. The glass may be amorphous glass or crystallized glass. For example, the ceramic material preferably includes 50% to 100% by mass of glass powder and 0% to 50% by mass of ceramic powder. Although the composition of the glass powder is not particularly limited, for example, the glass powder has a composition including 20% to 70% by mass of SiO₂, 0.5% to 30% by mass of Al₂O₃, and 3% to 60% by mass of MgO, and optionally, 0% to 35% by mass of CaO, 0% to 30% by mass of BaO, 0% to 30% by mass of SrO, 0% to 20% by mass of B₂O₃, 0% to 30% by mass of ZnO, 0% to 10% by mass of TiO₂, 0% to 3% by mass of Na₂O, and 0% to 5% by mass of Li₂O.

Examples of the ceramic powder include at least one selected from Al₂O₃, SiO₂, MgTiO₃, CaZrO₃, CaTiO₃, Mg₂SiO₄, BaTi₄O₉, ZrTiO₄, SrTiO₃, BaTiO₃, and TiO₂.

By combining the glass powder and the ceramic powder having the composition described above, it is possible to achieve sintering at a low temperature of 1,000° C. or lower, and it is also possible to form a conductor layer using a low-resistance conductor, such as Cu, Ag, Au, Pd, or Pt. Furthermore, a lower dielectric constant can be obtained, which is suitable for higher speed transmission. Moreover, by controlling the composition variously within the range described above, it is possible to easily control and change firing shrinkage behaviors.

With respect to the average particle size of the conductor powder, in order to suppress variation in firing, preferably, nanoparticles of less than 100 nm, in particular, 50 nm or less, are added to the ordinary conductor powder, for example, submicron particles (0.1 to 0.8 μm).

It is necessary to fabricate a laminate in which, when the ceramic green sheet B starts to shrink in the course of firing, the firing shrinkage of each of the ceramic green sheet A and the conductor layer has ended. Such a laminate can be manufactured by any of various methods, such as by changing the composition in the ceramic green sheet, or by changing the particle size of the metal powder in the conductor green sheet. The best method is to set the volume content (%) of each of the ceramic powder and the metal powder contained in the green sheets constituting the ceramic green sheet A, the ceramic green sheet B, and the conductor green sheet C at an appropriate value.

Specifically, given that the volume content of the ceramic powder in the ceramic green sheet A is B₁, the volume content of the ceramic powder in the ceramic green sheet B is B₂, and the volume content of the metal powder in the conductor green sheet C is B₃, the ratio B₁/B₂ is preferably 0.90 or more, and more preferably 0.95 or more. The reason for this is that since the temperature difference (T₂−T₃) increases, a desired laminate can be fabricated more stably.

The ratio B₃/B₂ is preferably 0.90 or more, and more preferably 0.95 or more. The reason for this is that since the temperature difference (T₂−T₄) increases, a desired laminate can be fabricated more stably.

In the firing profile for firing the laminate described above, by setting the temperature rising rate at 15° C./min or less, preferably 10° C./min or less, and more preferably 6° C./min or less in the temperature range of T₁ and T₂, a desired laminate can be fabricated more stably.

A method for manufacturing a wiring board according to an embodiment of the present invention will be described in more detail below. First, a ceramic green sheet A and a ceramic green sheet B exhibiting different firing shrinkage behaviors are formed. With respect to each of the ceramic green sheets A and B, predetermined ceramic powder, an organic binder, an organic solvent, and a plasticizer, and according to need, a dispersant are mixed and formed into a slurry. Tape forming is performed by a doctor blade process or the like using the slurry, and the resulting tape is cut to a predetermined size to obtain green sheets.

At this time, the ratio B₁/B₂ of the volume content B₁ of the ceramic powder of the ceramic green sheet A to the volume content B₂ of the ceramic powder of the ceramic green sheet B is set at 0.90 or more so that the firing shrinkage end temperature T₃ of the ceramic green sheet A is lower than the firing shrinkage start temperature T₂ of the ceramic green sheet B. In order to form each of the ceramic green sheets A and B, it is necessary to set the slurry compositions (selection of the functional group of the binder, selection of the dispersant, and the determination of the amount of addition) or the kneading conditions in an appropriate manner.

Subsequently, some of the ceramic green sheets A and B are subjected to punching or the like to form through-holes, and the through-holes are filled with a conductive paste to form via-hole conductor 4. In order to form surface conductor layers and internal wiring layers, a paste obtained using a predetermined conductive material is applied to the surface of each of some of the ceramic green sheets A and B by screen printing or the like.

At this time, the ratio B₃/B₂ of the volume content B₃ of the metal powder of the conductor layer to the volume content B₂ of the ceramic powder of the ceramic green sheet B is set at 0.90 or more so that the firing shrinkage end temperature T₄ of the conductor layer as well as the via-hole conductor is lower than the firing shrinkage start temperature T₂ of the ceramic green sheet B. In order to form such a conductor layer, it is necessary to set the slurry composition for forming the conductor green sheet C (selection of the binder, selection of the dispersant, and the determination of the amount of addition) or the kneading conditions in an appropriate manner.

The individual ceramic green sheets A and B thus obtained are stacked in a predetermined stacking order, and thereby a laminate is formed.

The resulting laminate is subjected to firing. In the firing process, first, the firing temperature reaches the shrinkage start temperature T₁ of the ceramic green sheet A, and then firing is performed at a temperature rising rate of preferably 15° C./min or less, and more preferably 10° C./min or less. At this stage, the firing shrinkage in the X-Y plane direction of each of the ceramic green sheet A and the conductor layer is suppressed by the ceramic green sheet B which does not shrink in the course of firing at the temperature, and the ceramic green sheet A and the conductor layer shrink in the Z direction in the course of firing. When the firing temperature further increases and reaches the shrinkage start temperature T₂ of the ceramic green sheet B, the firing shrinkage in the X-Y plane direction of the ceramic green sheet B is suppressed by the ceramic green sheet A and the conductor layer in which the firing shrinkage has substantially ended, and the ceramic green sheet B shrinks in the Z direction in the course of firing. As a result, a substrate with little warpage can be obtained in which the firing shrinkage in the X-Y plane direction of each of the ceramic green sheet A, the ceramic green sheet B, and the conductor layer is suppressed, and firing shrinkage occurs in the Z direction.

Furthermore, in the laminate according to an embodiment of the present invention, it is desirable to decrease the difference in temperature between the front and back surfaces of the laminate during firing. Specifically, it is desirable to reduce the contact area between the laminate and a firing setter placed at the back surface of the laminate. For that purpose, the firing setter may be composed of a sintered porous body having a porosity of, for example, 30% or more, or through-holes or grooves may be formed in the firing setter.

In general, the back surface of the laminate which comes into contact with a firing jig (firing setter) tends to have a lower temperature than the front surface of the laminate. In some cases, the time required for firing of the ceramic green sheets A and B and the conductor layer which are brought into contact with the firing setter may be long compared with the ceramic green sheets A and B and the conductor layer at the front surface of the laminate, resulting in an increase in warpage of the laminate. In order to overcome such a problem, by controlling the contact state with the firing setter or by adjusting the firing-setting method appropriately, it is possible to decrease the difference in temperature between the front and back surfaces of the laminate during firing, and a substrate with little warpage can be fabricated.

Furthermore, a firing setter may be placed at the front surface of the laminate. In such a case, the firing setter placed at the front surface of the laminate may be disposed directly on the laminate. Alternatively, a spacer may be disposed on a setter to be placed on the back surface of the laminate or on a firing furnace, and the firing setter to be placed at the front surface of the laminate may be disposed on the spacer so that the laminate and the firing setter placed at the front surface of the laminate are not in direct contact with each other. By disposing the firing setter directly on the laminate, warpage of the laminate during firing can be further suppressed because a load is applied from the flat firing setter. By disposing the firing setter so as not to be in direct contact with the laminate, it is possible to inhibit conduction of heat from the firing setter, which is directly heated by the radiation heat from the firing furnace, to the laminate, and it is possible to decrease the difference in temperature between the front and back surfaces of the laminate.

### EXAMPLE

Wiring boards having a structure shown in FIG. 1 were fabricated. Ceramic powder A used for a ceramic green sheet A includes 80% by mass of glass powder A and 20% by mass of Al₂O₃ powder having an average particle size of about 1 μm. The glass powder A includes 8% by weight of SiO₂, 15% by weight of Al₂O₃, 40% by weight of MgO, 4.1% by weight of CaO, 7.1% by weight of BaO, 14% by weight of B₂O₃, 1.5% by weight of ZnO, 2.5% by weight of TiO₂, 5.4% by weight of Na₂O, and 2.4% by weight of Li₂O.

Ceramic powder B used for a ceramic green sheet B includes 60% by mass of glass powder B and 40% by mass of Al₂O₃ powder having an average particle size of about 1 μm. The glass powder B includes 45.5% by weight of SiO₂, 5% by weight of Al₂O₃, 15% by weight of MgO, 27% by weight of CaO, 2.5% by weight of BaO, 2.0% by weight of B₂O₃, and 3.0% by weight of SrO.

As the glass powder B used for the ceramic powder B, two types of powder, i.e., glass powder having an average particle size of 3.2 μm and glass powder having an average particle size of 2.0 μm, were prepared. The firing shrinkage start temperature of the green sheet including the glass powder having an average particle size of 3.2 μm is higher than the firing shrinkage start temperature of the green sheet including the glass powder having an average particle size of 2.0 μm. A binder and a dispersant suitable for each material were added to each of the ceramic powder A and the ceramic powder B, followed by kneading to produce a slurry. The resulting slurry was formed into each ceramic green sheet by a doctor blade process. The ceramic green sheets A and the ceramic green sheets B with varied contents of the ceramic powders were prepared as shown in Table 1.

Conductive pastes were prepared in order to form conductor layers. Ag or Cu conductor powder having an average particle size of 0.5 μm was mixed with 10% by weight of metal nanoparticles with an average particle size of 50 nm, and a binder was added thereto to form a conductive paste.

Each laminate had the same structure as that shown in FIG. 1. A through-hole was formed in each of the corresponding green sheets, and the through-hole was filled with a conductive paste containing Ag or Cu powder. Conductor patterns, which were to be formed into surface wiring layers and internal wiring layers after firing, were formed by printing on the surfaces of the ceramic green sheets, followed by drying to form conductor layers. As the conductive materials for forming the front surface wiring layers, internal wiring layers, and back surface wiring layers, Ag or Cu powder was used. An organic vehicle and a surfactant were added to the conductive materials, and the mixtures were mixed using a three-roller mill to form pastes. Thus, conductive layers having different volume contents of metal powder as shown in Table 1 were prepared.

The ceramic green sheets were aligned and stacked to form each laminate. In the case of Ag wiring, the laminate was subjected to debinding treatment in air at 400° C., and then was fired in air at 910° C. to produce a wiring board. In the case of Cu wiring, the laminate was subjected to debinding treatment in a reducing atmosphere at 700° C., and then was fired at 910° C. to produce a wiring board.

As firing setters, a porous material containing Al₂O₃—SiO₂ as a principal component was used. As the firing setter to be placed at the back surface of the laminate, a firing setter having a thickness of 3 mm with a through-hole having a diameter of about 1 mm, a firing setter having a thickness of 3 mm without a through-hole, or a firing setter having thickness of 1 mm without a through-hole was used. In one sample, firing setting was changed by providing a spacer between the bottom face of the firing setter and a firing furnace so that heat was applied easily from the bottom of the firing setter.

In some of the laminates, firing was performed with a firing setter being also placed at the front surface thereof. As the firing setter to be placed at the front surface of the laminate, a firing setter having a thickness of 3 mm without a through-hole was used. When firing was performed, a spacer was disposed on the firing setter placed at the back surface of the laminate, the firing setter to be placed at the front surface of the laminate was disposed on the spacer so that the laminate was not in direct contact with the firing setter placed at the front surface of the laminate.

Here, the thickness of the ceramic green sheet A was set at 50 μm, and the thickness of the ceramic green sheet B was set at 100 μm. In order to determine the volume content of the ceramic powder in each of the green sheets, the density of the green sheet before firing (g/cm³) was measured, and then calculation was made on the basis of the measured value, the density of the ceramic powder, the density of the additive contained in the slurry, and the composition of the green sheet.

In order to examine the firing shrinkage behaviors of the ceramic green sheet A, the ceramic green sheet B, and the conductor green sheet C, holes were formed in each of the green sheets. In the middle of firing, each green sheet was taken out from the firing furnace, and the distance between holes was measured to obtain a dimensional change. The shrinkage was calculated from the dimensional change for each green sheet, and thereby, the shrinkage start temperature T₁ of the ceramic green sheet A, the shrinkage end temperature T₃ of the ceramic green sheet A, the shrinkage start temperature T₂ of the ceramic green sheet B, and the shrinkage end temperature T₄ of the conductor green sheet C were obtained. The conductor green sheet C used for the measurement had a thickness of 100 μm, the conductor green sheet C being prepared by repeating the step of printing and drying a plurality of times.

With respect to the wiring boards thus fabricated, warpage in the X-Y plane direction was evaluated. The samples used for evaluation had the same structure as that shown in FIG. 1. In each sample, irregularities in the vicinity of a 7 mm square electrode were measured using a three-dimensional measuring device. The difference between the maximum height and the minimum height of the irregularities was defined as the amount of warpage. The results thereof are shown in

TABLE 1

| | Volume content of | | | | | | | |
|---|---|---|---|---|---|---|---|---|
| | ceramic powder or metal | | | | | Firing | | |
| | powder in green sheet | | | | | profile | | |
| | vol %) | | | | | Temperature | | |
| | Ceramic | Ceramic | Conductor | | | rising | Firing setter | |
| | green | green | green | | | rate from | placed at front | Firing setter placed |
| Sample | sheet A | sheet B | sheet C | | | T₁ to T₂ | surface of | at back surface of |
| No. | B₁ | B₂ | B₃ | B₁/B₂ | B₃/B₂ | (° C./min) | laminate | laminate |
| *1 | 45 | 52 | 42 | 0.87 | 0.81 | 10 | None | 3 mm/without hole |
| *2 | 47 | 52 | 42 | 0.90 | 0.81 | 10 | None | 3 mm/without hole |
| 3 | 49 | 52 | 47 | 0.94 | 0.90 | 10 | None | 3 mm/without hole |
| 4 | 56 | 52 | 47 | 1.08 | 0.90 | 10 | None | 3 mm/without hole |
| 5 | 51 | 52 | 50 | 0.98 | 0.96 | 10 | None | 3 mm/without hole |
| 6 | 51 | 48 | 54 | 1.06 | 1.13 | 10 | None | 3 mm/without hole |
| 7 | 52 | 57 | 52 | 0.91 | 0.91 | 15 | None | 3 mm/without hole |
| 8 | 52 | 57 | 52 | 0.91 | 0.91 | 6 | None | 3 mm/without hole |
| 9 | 51 | 52 | 50 | 0.98 | 0.96 | 10 | None | 1 mm/without hole |
| 10 | 51 | 52 | 50 | 0.98 | 0.96 | 10 | None | 3 mm/with hole |
| 11 | 51 | 52 | 50 | 0.98 | 0.96 | 10 | None | 3 mm/with spacer |
| 12 | 56 | 52 | 52 | 1.08 | 1.00 | 10 | None | 3 mm/without hole |
| 13 | 52 | 57 | 52 | 0.91 | 0.91 | 10 | 3 mm/without | 3 mm/without hole |
| | | | | | | | hole | |
| *14 | 45 | 52 | 42 | 0.87 | 0.81 | 10 | 3 mm/without | 3 mm/without hole |
| | | | | | | | hole | |
| 15 | 43 | 52 | 42 | 0.83 | 0.81 | 10 | None | 3 mm/without hole |
| 16 | 47 | 52 | 42 | 0.90 | 0.81 | 10 | None | 3 mm/without hole |

| | | | Ceramic green | | | | | | |
|---|---|---|---|---|---|---|---|---|---|
| | | | sheet B | | | | | | |
| | Ceramic green | | Particle | | Conductor green | | | | |
| | sheet A | | size of | | sheet C | | Relationship | | Amount |
| | Shrinkage | Shrinkage | glass | Shrinkage | | Shrinkage | with T₂ | | of |
| Sample | start | end | powder | start | Metal | end | T₂ − T₃ | T₂ − T₄ | warpage |
| No. | T₁(° C.) | T₃(° C.) | (μm) | T₂(° C.) | powder | T₄(° C.) | ° C. | ° C. | μm |
| *1 | 660 | 735 | 2.0 | 745 | Ag | 780 | 10 | −35 | 75 |
| *2 | 640 | 730 | 2.0 | 745 | Ag | 780 | 15 | −35 | 53 |
| 3 | 630 | 720 | 2.0 | 745 | Ag | 740 | 25 | 5 | 24 |
| 4 | 600 | 710 | 2.0 | 745 | Ag | 740 | 35 | 5 | 26 |
| 5 | 620 | 720 | 2.0 | 745 | Ag | 720 | 25 | 25 | 20 |
| 6 | 620 | 720 | 2.0 | 755 | Ag | 715 | 35 | 40 | 18 |
| 7 | 620 | 725 | 2.0 | 732 | Ag | 730 | 7 | 2 | 34 |
| 8 | 620 | 710 | 2.0 | 725 | Ag | 710 | 15 | 15 | 22 |
| 9 | 620 | 720 | 2.0 | 745 | Ag | 720 | 25 | 25 | 10 |
| 10 | 620 | 720 | 2.0 | 745 | Ag | 720 | 25 | 25 | 9 |
| 11 | 620 | 720 | 2.0 | 745 | Ag | 720 | 25 | 25 | 12 |
| 12 | 600 | 710 | 2.0 | 745 | Cu | 735 | 35 | 10 | 21 |
| 13 | 620 | 725 | 2.0 | 732 | Ag | 730 | 7 | 2 | 15 |
| *14 | 660 | 745 | 2.0 | 745 | Ag | 780 | 0 | −35 | 72 |
| 15 | 665 | 740 | 3.2 | 785 | Ag | 780 | 45 | 5 | 48 |
| 16 | 645 | 735 | 3.2 | 785 | Ag | 780 | 50 | 5 | 42 |

Asterisk (*) indicates the sample which is out of the ranges of the present invention.

As is evident from Table 1, in samples Nos. 3 to 13, 15, and 16 according to embodiments of the present invention, since T₂ is higher than T₃ and T₄, the amount of warpage is small at 48 μm or less. In samples Nos. 3 to 13 and 16, in which T₂ is higher than T₃ and T₄, and B₁/B₂ is 0.90 or more, the amount of warpage is small at 42 μm or less. Furthermore, in samples Nos. 3 to 13, in which T₂ is higher than T₃ and T₄, B₁/B₂ is 0.90 or more, and B₃/B₂ is 0.90 or more, the amount of warpage is small at 34 μm or less.

In contrast, in samples Nos. 1, 2, and 14, in which T₂ is not higher than T₃ or T₄, the amount of warpage is 53 μm or more, i.e., larger than that of the products according to embodiments of the present invention. It has also been confirmed that if the temperature rising rate from T₁ to T₂ during firing is 15° C./min or less, it is possible to increase the differences in temperature between T₂ and T₃ and between T₂ and T₄, and the amount of warpage can also be decreased. Furthermore, by decreasing the thickness of the firing setter placed on the back surface of the sample, forming a through-hole in the firing setter, by providing a spacer on the firing setter, the difference in temperature between the front and back surfaces of the sample can be decreased, and thus the amount of warpage can be decreased. Furthermore, by placing a firing setter on the front surface of the sample, the amount of warpage can be decreased.

Obviously, numerous modifications and variations of the present invention are possible in light of the above teachings. It is therefore to be understood that within the scope of the appended claims, the invention may be practiced otherwise than as specifically described herein.

What is claimed is:

1. A laminate comprising:
a first ceramic green sheet including ceramic powder and an organic binder and having a firing shrinkage end temperature T₃;
a second ceramic green sheet including ceramic powder and an organic binder and having a firing shrinkage start temperature T₂ that is higher than the firing shrinkage end temperature T₃ of the first ceramic green sheet; and
a conductor layer including metal powder and an organic binder and having a firing shrinkage end temperature T₄ that is lower than the firing shrinkage start temperature T₂ of the second ceramic green sheet.

2. The laminate according to claim 1, wherein the ceramic powder contained in the first ceramic green sheet comprises glass powder.

3. The laminate according to claim 1, wherein the ceramic powder contained in the second ceramic green sheet comprises glass powder.

4. The laminate according to claim 1, wherein the metal powder contained in the conductor layer comprises at least one of Au, Ag, Cu, Pd and Pt, and wherein the metal powder contains metal nanoparticles.

5. The laminate according to claim 1, wherein a ratio B₁/B₂ is 0.90 or more, in which B₁ represents a volume content of the ceramic powder contained in the first ceramic green sheet, and B₂ represents a volume content of the ceramic powder contained in the second ceramic green sheet.

6. The laminate according to claim 1, wherein a ratio B₃/B₂ is 0.90 or more, in which B₂ represents a volume content of the ceramic powder contained in the second ceramic green sheet, and B₃ represents a volume content of the metal powder contained in the conductor layer.

7. A method for manufacturing a laminate comprising the steps of:
preparing at least one first ceramic green sheet containing ceramic powder and an organic binder;
preparing at least one second ceramic green sheet containing ceramic powder and an organic binder and having a firing shrinkage start temperature T₂ that is higher than a firing shrinkage end temperature T₃ of said at least one first ceramic green sheet;
preparing a conductive paste containing metal powder and an organic binder, the conductive paste having a firing shrinkage end temperature T₄ that is lower than the firing shrinkage start temperature T₂ of said at least one second ceramic green sheet;
applying the conductive paste to a surface of at least one of said at least one first ceramic green sheet and to a surface of at least one of said at least one second ceramic green sheet, or filling a through-hole provided on at least one of said at least one first ceramic green sheet and at least one of said at least one second ceramic green sheet with the conductive paste; and
stacking said at least one first ceramic green sheet and said at least one second ceramic green sheet including said at least one of said at least one first ceramic green sheet and said at least one of said at least one second ceramic green sheet on which the conductive paste is applied or whose through-hole is filled with the conductive paste.

8. The method for manufacturing the laminate according to claim 7, wherein, in the step of preparing the first ceramic green sheets, glass powder is used as the ceramic powder.

9. The method for manufacturing the laminate according to claim 7, wherein, in the step of preparing the second ceramic green sheets, glass powder is used as the ceramic powder.

10. The method for manufacturing the laminate according to claim 7, wherein, in the step of preparing the conductive paste, the metal powder comprises at least one of Au, Ag, Cu, Pd, and Pt, and the metal powder is mixed powder including submicron particles having an average particle size of 0.1 μm or more and metal nanoparticles having an average particle size of less than 100 nm.

11. The method for manufacturing the laminate according to claim 7, wherein a volume content B₁ of the ceramic powder contained in each of the first ceramic green sheets and a volume content B₂ of the ceramic powder contained in each of the second ceramic green sheets are adjusted so that a ratio B₁/B₂ is 0.90 or more.

12. The method for manufacturing the laminate according to claim 7, wherein a volume content B₂ of the ceramic powder contained in each of the second ceramic green sheets and the volume content B₃ of the metal powder contained in the conductive paste are adjusted so that a ratio B₃/B₂ is 0.90 or more.

13. A method for manufacturing a wiring board comprising the steps of:
preparing at least one first ceramic green sheet containing ceramic powder and an organic binder;
preparing at least one second ceramic green sheet containing ceramic powder and an organic binder and having a firing shrinkage start temperature T₂ that is higher than a firing shrinkage end temperature T₃ of said at least one first ceramic green sheet;
preparing a conductive paste containing metal powder and an organic binder, the conductive paste having a firing shrinkage end temperature T₄ that is lower than the firing shrinkage start temperature T₂ of said at least one the second ceramic green sheet;
applying the conductive paste to a surface of at least one of said at least one first ceramic green sheet and to a surface of at least one of said at least one second ceramic green sheet, or filling a through-hole provided on at least one of said at least one first ceramic green sheet and at least one of said at least one second ceramic green sheet with the conductive paste;
stacking said at least one first ceramic green sheet and said at least one second ceramic green sheet including said at least one of said at least one first ceramic green sheet and said at least one of said at least one second ceramic green sheet on which the conductive paste is applied or whose through-hole is filled with the conductive paste, to form a laminate; and
firing the laminate.

14. The method for manufacturing the wiring board according to claim 13, wherein, in the step of preparing the first ceramic green sheets, glass powder is used as the ceramic powder.

15. The method for manufacturing the wiring board according to claim 13, wherein, in the step of preparing the second ceramic green sheets, glass powder is used as the ceramic powder.

16. The method for manufacturing the wiring board according to claim 13, wherein, in the step of preparing the conductive paste, the metal powder comprises at least one of Au, Ag, Cu, Pd, and Pt, and the metal powder is mixed powder including submicron particles having an average particle size of 0.1 μm or more and metal nanoparticles having an average particle size of less than 100 nm.

17. The method for manufacturing the wiring board according to claim 13, wherein a volume content B₁ of the ceramic powder contained in each of the first ceramic green sheets and a volume content B₂ of the ceramic powder contained in each of the second ceramic green sheets are adjusted so that a ratio B₁/B₂ is 0.90 or more.

18. The method for manufacturing the wiring board according to claim 13, wherein a volume content B₂ of the ceramic powder contained in each of the second ceramic green sheets and a volume content B₃ of the metal powder contained in the conductive paste are adjusted so that a ratio B₃/B₂ is 0.90 or more.
